(19) United States
(12) Patent Application Publication
(10) Pub. No.: US 2026/0045747 A1
(43) Pub. Date: Feb. 12, 2026

(54) CONNECTOR

(71) Applicant: BIZLINK INTERNATIONAL CORP., New Taipei City (TW)

(72) Inventors: Hongping SU, New Taipei City (TW); Haoran ZOU, New Taipei City (TW); Qixing XU, New Taipei City (TW)

(21) Appl. No.: 18/798,811

(22) Filed: Aug. 9, 2024

(51) Int. Cl. H01R 25/14; H01R 4/48

(52) U.S. Cl. CPC H01R 25/142; H01R 4/4811

(57) ABSTRACT

A connector includes a housing and a terminal. The housing includes a bottom portion, an extending portion, and a supporting portion. The extending portion protrudes from the bottom portion. The supporting portion is located in the bottom portion. The terminal is connected to the housing. The terminal includes a main body and an extending arm extending from the main body. The extending arm abuts against the supporting portion. The extending arm is wavy-shaped.

### BACKGROUND

### Field of Invention

The present invention relates to a connector, and specifically, to a busbar clip connector.

### Description of Related Art

Generally, a busbar clip connector of a server includes two conductive terminals that are in contact with the copper busbar.

To meet the functional requirement that the conductive terminals can be fixed firmly on the housing, some solutions have been described in the conventional art. For example, the Chinese patent of patent No. CN217545118U discloses a connector, including a main body, a first grounded terminal and a second grounded terminal connected to the main body, and a first power terminal and a second power terminal fixedly disposed inside the main body. The first power terminal and the second power terminal individually have positioning holes. The main body has a plurality of positioning bumps coupled to the positioning holes. However, the combination of positioning holes and the positioning bumps is not able to ensure the first power terminal and the second power terminal consistently fastened on the main body, as the main body deteriorates (e.g., the brittleness induced by high temperature due to repeated usage).

How to propose a connector that can solve the aforementioned problems is one of the problems that the industry is currently eager to invest in research and development resources to solve.

### SUMMARY

In view of this, one purpose of the present disclosure is to provide a connector that can solve the aforementioned problems.

In order to achieve the above objective, according to an embodiment of the present disclosure, a connector includes a housing and a terminal. The housing includes a bottom portion, an extending portion and a supporting portion. The extending portion protrudes from the bottom portion. The supporting portion is located in the bottom portion. The terminal is connected to the extending portion. The terminal includes a main body and an extending arm extending from the main body. The extending arm abuts against the supporting portion. The extending arm is wavy-shaped. A bottom surface of an abutting portion of the extending arm abuts against a top surface of a platform of the supporting portion of the housing.

In summary, in the connector of the present disclosure, since the bottom surface of the abutting portion of the extending arm abuts against the top surface of the platform of the supporting portion of the housing, the extending arm can stand more firmly relative to the housing, thereby achieving the purpose of improving the effect of fixing.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a perspective view of a connector in accordance with an embodiment of the present disclosure;

FIG. 2 is a perspective view of a terminal in accordance with an embodiment of the present disclosure;

FIG. 3A is a sided view of the terminal in accordance with an embodiment of the present disclosure;

FIG. 3B is another sided view of the terminal in accordance with an embodiment of the present disclosure;

FIG. 4 is a three-dimensional cross-sectional view of the connector in accordance with an embodiment of the present disclosure; and

FIG. 5 is an enlarged view of the connector in FIG. 4 in accordance with an embodiment of the present disclosure.

### DETAILED DESCRIPTION

Hereinafter, a plurality of embodiments of the present disclosure will be disclosed in diagrams. For the sake of clarity, many details in practice will be described in the following description. However, it should be understood that these details in practice should not limit present disclosure. In other words, in some embodiments of present disclosure, these details in practice are unnecessary. In addition, for simplicity of the drawings, some conventionally used structures and elements will be shown in a simple schematic manner in the drawings. The same reference numbers are used in the drawings and the description to refer to the same or like parts.

Hereinafter, the structure and function of each component included in the connector 100 of this embodiment and the connection relationship between the components will be described in detail.

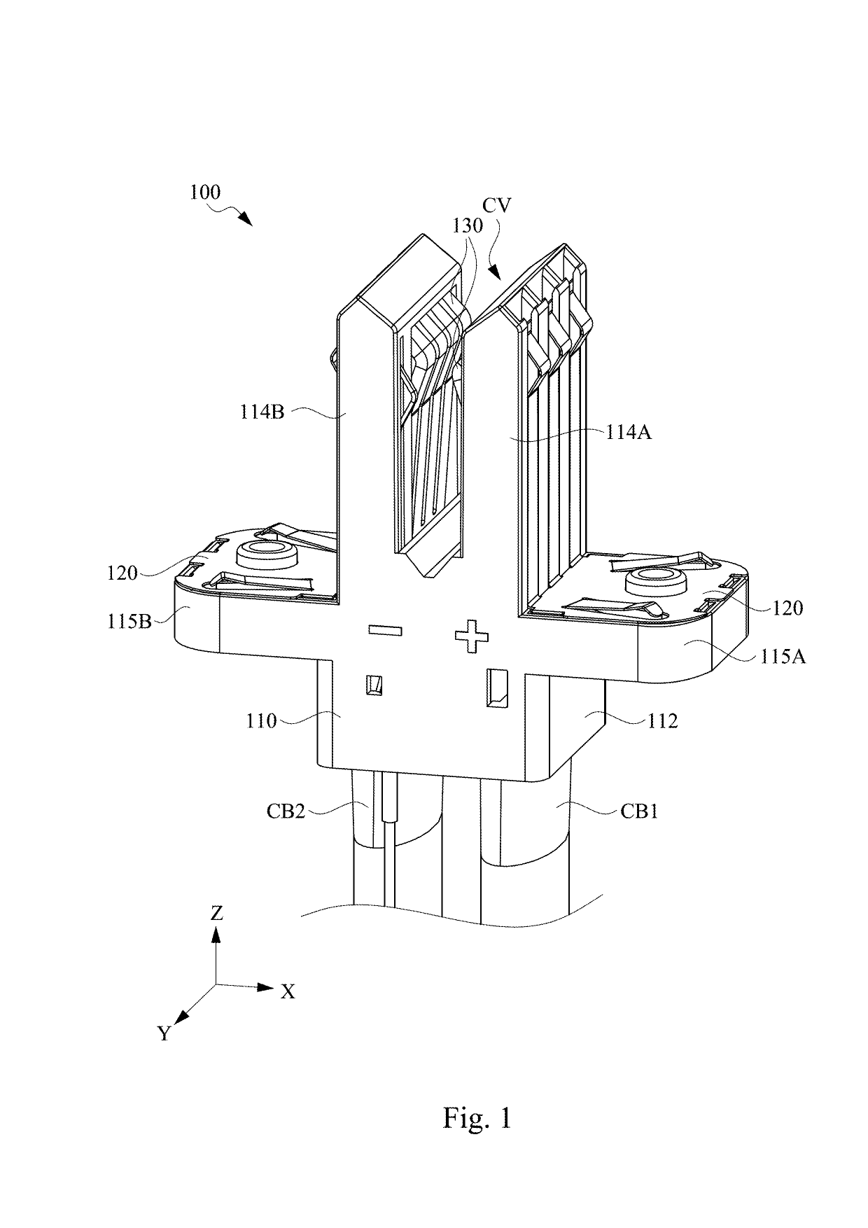

Reference is made to FIG. 1. FIG. 1 is a perspective view of the connector 100 in accordance with an embodiment of the present disclosure. As shown in FIG. 1, in this embodiment, the connector 100 includes a housing 110, two grounded sheets 120, and two terminals 130. The housing 110 includes a bottom portion 112, a first extending portion 114A, a second extending portion 114B, a wing portion 115A, and a wing portion 115B. The first extending portion 114A and the second extending portion 114B protrude from the bottom portion 112. The wing portion 115A and the wing portion 115B are laterally connected to the first extending portion 114A and the second extending portion 114B. The wing portion 115A and the wing portion 115B laterally surround the first extending portion 114A and the second extending portion 114B. The wing portion 115A is located between the bottom portion 112 and the first extending portion 114A. The wing portion 115B is located between the bottom portion 112 and the second extending portion 114B. The bottom portion 112, the first extending portion 114A, and the second extending portion 114B jointly define a cavity CV.

As shown in FIG. 1, the two grounded sheets 120 are connected to the housing 110. More specifically, the two grounded sheets 120 are respectively connected to the first extending portion 114A and the second extending portion 114B. The two terminals 130 are connected to the housing 110. More specifically, the two terminals 130 are respectively connected to the first extending portion 114A and the second extending portion 114B. The two grounded sheets 120 are separated from the two terminals 130. As shown in FIG. 1, one of the two grounded sheets 120 is connected to the first extending portion 114A and the wing portion 115A, and the other one of the two grounded sheets 120 is connected to the second extending portion 114B and the wing portion 115B. The two terminal 130 is partly located in the cavity CV. In this embodiment, the bottom portion 112 of the connector 100 is connected to a first cable CB1 and a second cable CB2. The first cable CB1 is electrically connected to one of the two terminals 130 connected to the first extending portion 114A. The second cable CB2 is electrically connected to the other one of the two terminals 130 connected to the second extending portion 114B.

As shown in FIG. 1, in some embodiments, the first extending portion 114A and the second extending portion 114B protrude from the bottom portion 112 along a direction (e.g., z-direction). In some embodiments, the first extending portion 114A and the second extending portion 114B are arranged in a direction (e.g., x-direction). The wing portion 115A and the wing portion 115B laterally extend from the bottom portion 112 and are perpendicular to the first extending portion 114A and the second extending portion 114B.

In some embodiments, the housing 110 may be, for example, an insulator or other suitable material. The present disclosure is not intended to limit the material of the housing 110.

In some embodiments, the two grounded sheets 120 may be composed of, for example, a metallic material, an alloy material, or other suitable materials. The present disclosure is not intended to limit the material of the two grounded sheets 120.

In some embodiments, the two terminals 130 may be, for example, brass or other suitable conductive materials. The present disclosure is not intended to limit the material of the two terminals 130.

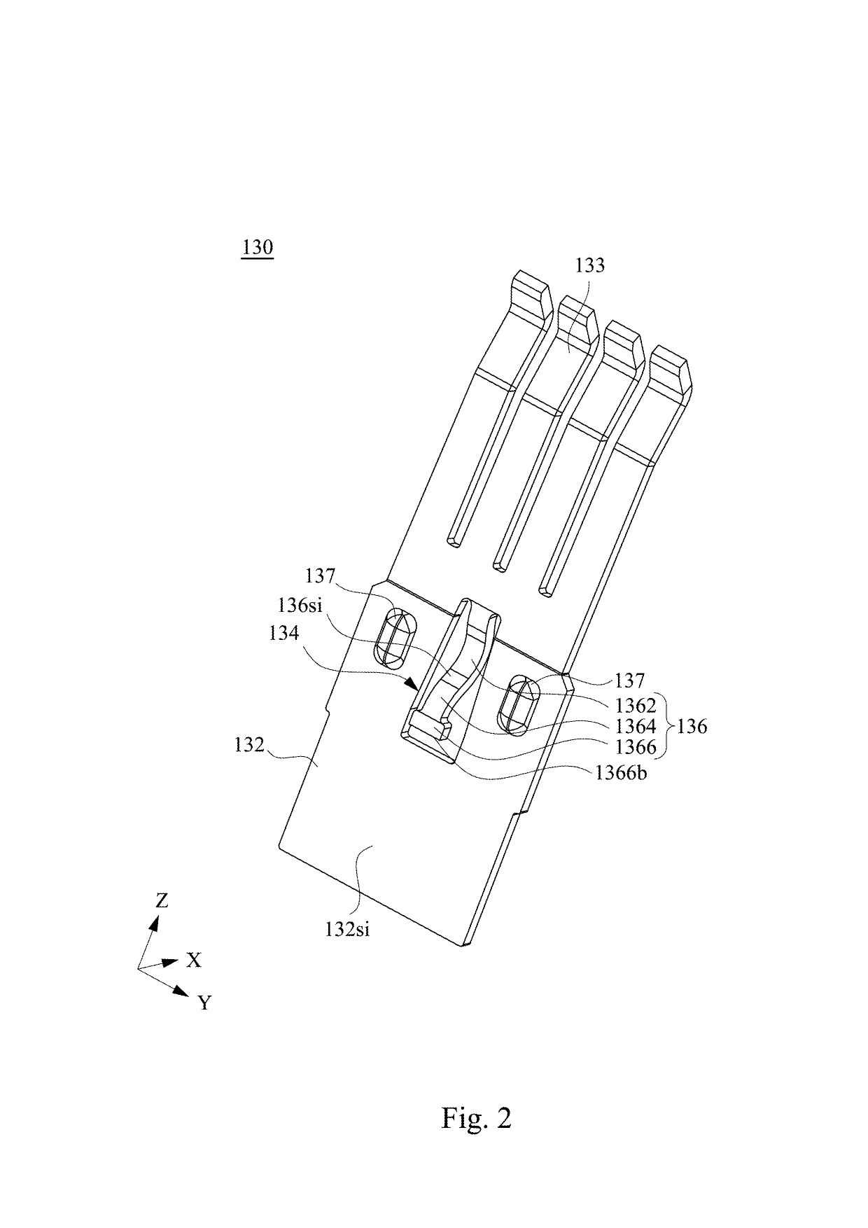

FIG. 2 is a perspective view of a terminal 130 in accordance with an embodiment of the present disclosure. The terminal 130 as shown in FIG. 2 is one of the two terminals 130 as shown in FIG. 1. As shown in FIG. 2, in this embodiment, the terminal 130 includes a main body 132, a curling portion 133, an opening 134, an extending arm 136, and a bump 137. The main body 132 has an inner surface 132si. The curling portion 133 protrudes from the main body 132. The opening 134 is located on the main body 132. The extending arm 136 extends from the main body 132 and is accommodated in the opening 134. As shown in FIG. 2, the extending arm 136 concavely and convexly bends relative to the main body 132. The extending arm 136 includes a first bending portion 1362, a second bending portion 1364, and an abutting portion 1366. The extending arm 136 has an inner surface 136si. The first bending portion 1362 extends from the main body 132 of the terminal 130. At least a part of the first bending portion 1362 is located at an inner side of the main body 132. The second bending portion 1364 is connected to the first bending portion 1362. At least a part of the second bending portion 1364 is located at an outer side of the main body 132. The abutting portion 1366 is connected to the second bending portion 1364. The abutting portion 1366 has a bottom surface 1366b. In some embodiments, the extending arm 136 is wavy-shaped. The bump 137 is located on the main body 132. In some embodiments, the terminal 130 includes a plurality of bumps 137. The bumps 137 are arranged in a direction (e.g., y-direction).

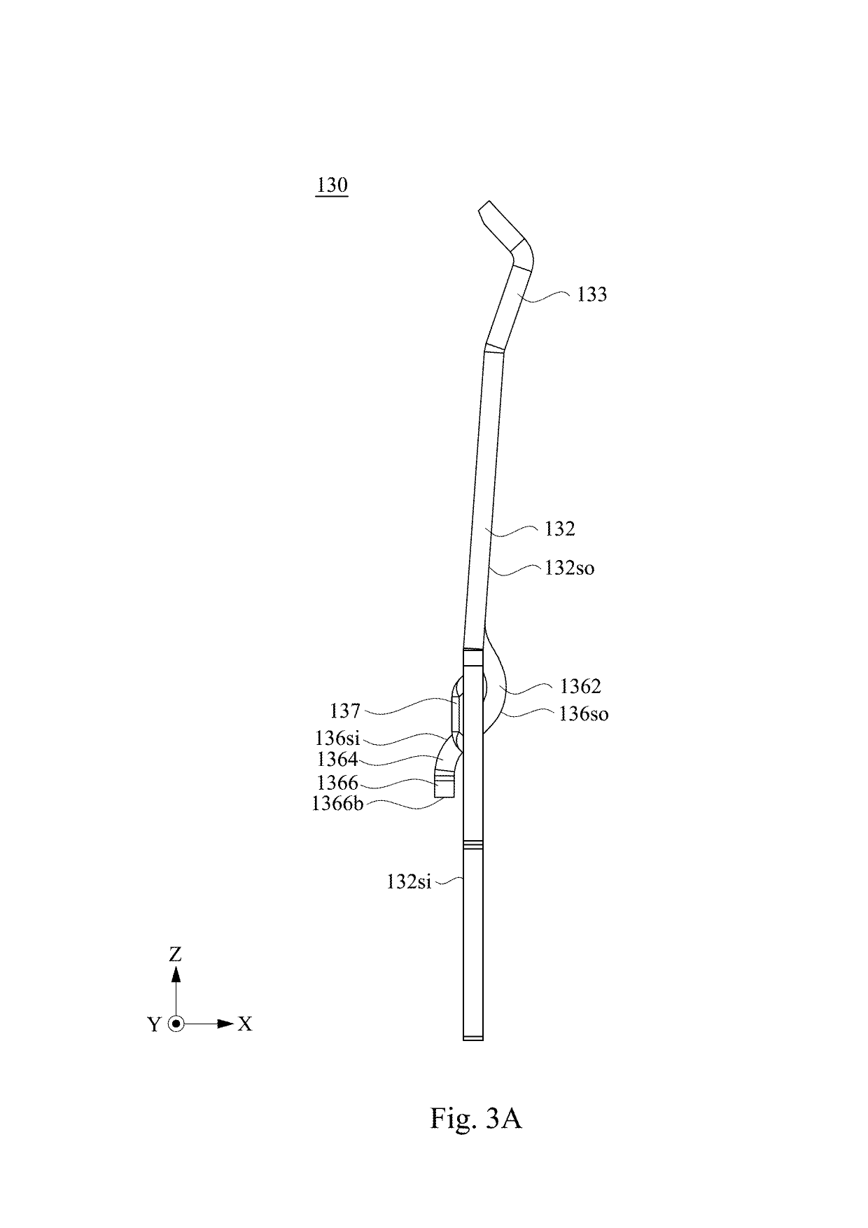

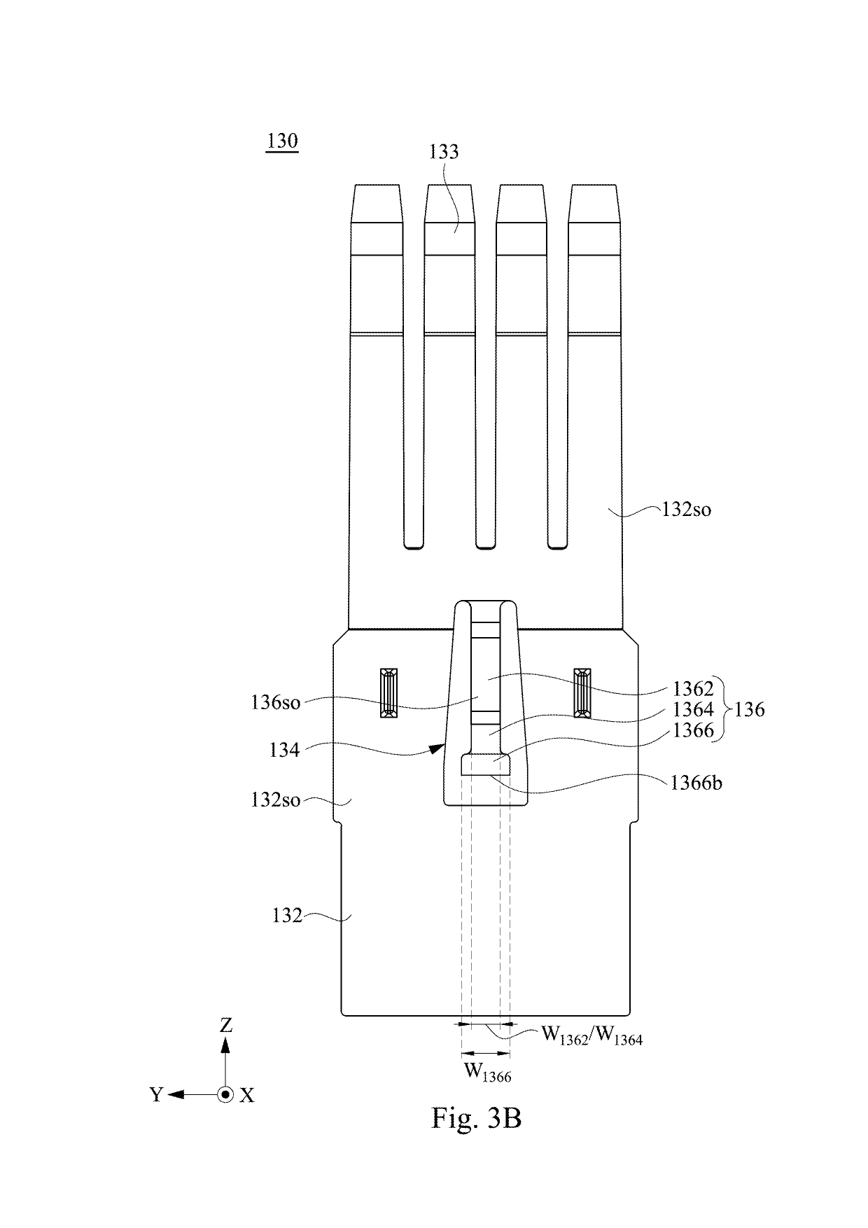

FIG. 3A is a sided view of the terminal 130 in accordance with an embodiment of the present disclosure. As shown in FIG. 3A, in this embodiment, the main body 132 of the terminal 130 further includes an outer surface 132so. The inner surface 132si and the outer surface 132so are located on both sides of the main body 132. In some embodiments, the bump 137 is located on the inner surface 132si. The extending arm 136 of the terminal 130 further includes an outer surface 136so. The inner surface 136si and the outer surface 136so are located on both sides of the extending arm 136. As shown in FIG. 3A, the extending arm 136 concavely and then convexly bends along a direction (e.g., z-direction). The first bending portion 1362 is raised with respect to the outer surface 132so of the main body 132. The second bending portion 1364 is raised with respect to the inner surface 132si of the main body 132.

FIG. 3B is another sided view of the terminal 130 in accordance with an embodiment of the present disclosure. In a view of FIG. 3B (that is, viewed from the x-direction penetrating outward the paper), the first bending portion 1362 has a width W₁₃₆₂ extending in a direction (e.g., y-direction). The second bending portion 1364 has a width W₁₃₆₄ extending in the direction (e.g., y-direction). The abutting portion 1366 has a width W₁₃₆₆ extending in the direction (e.g., y-direction). As shown in FIG. 3B, the width W₁₃₆₆ of the abutting portion 1366 is greater than the width W₁₃₆₄ of the second bending portion 1364. In this embodiment, the width W₁₃₆₆ of the abutting portion 1366 tapers upward along a direction (e.g., z-direction). As shown in FIG. 3B, in some embodiments, the abutting portion 1366 has an inverted capital-T shape in the view of FIG. 3B. In some other embodiments, the abutting portion 1366 has a triangular shape in the view of FIG. 3B.

In some embodiments, the width W₁₃₆₆ of the abutting portion 1366 is greater than the width W₁₃₆₂ of the first bending portion 1362. In some embodiments, the width W₁₃₆₂ of the first bending portion 1362 is equal to the width W₁₃₆₄ of the second bending portion 1364.

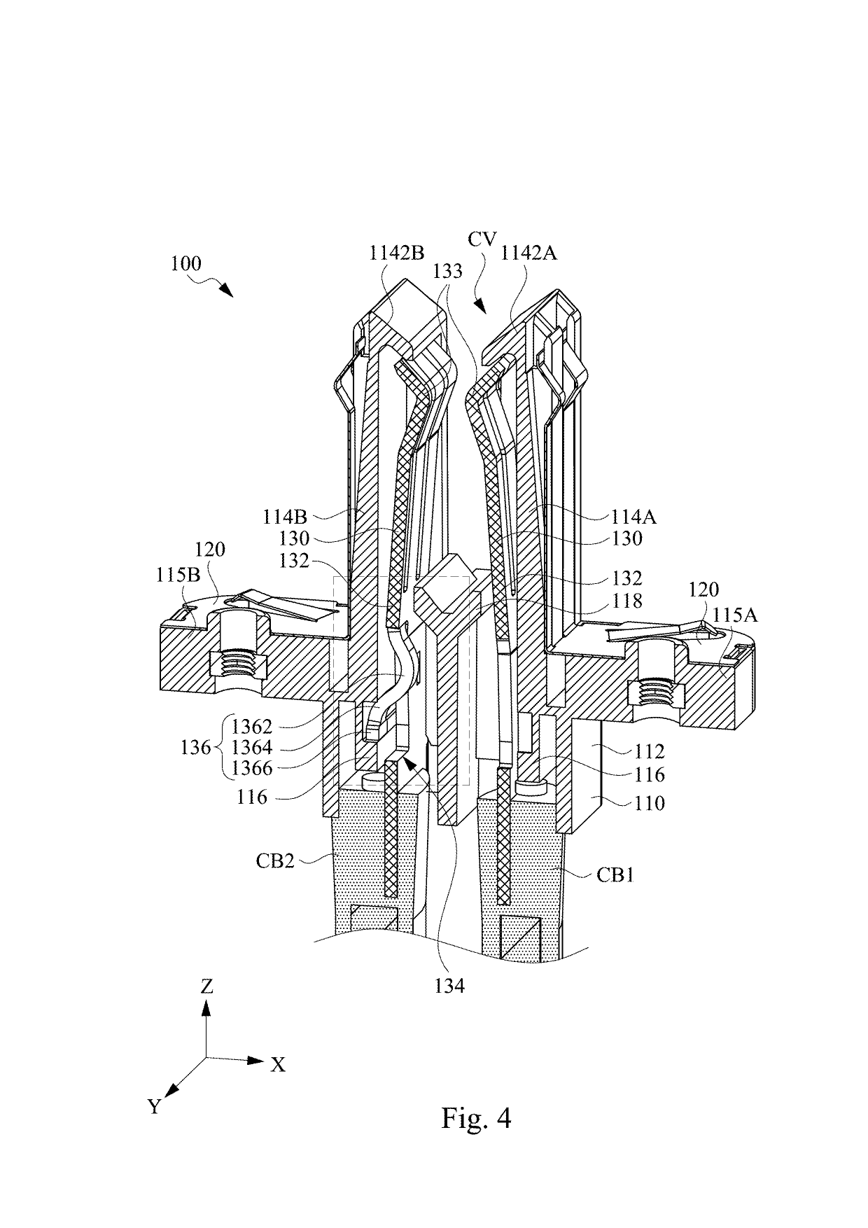

FIG. 4 is a three-dimensional cross-sectional view of the connector 100 in accordance with an embodiment of the present disclosure. As shown in FIG. 4, in this embodiment, the housing 110 further includes a supporting portion 116 and a spacer 118. The supporting portion 116 is connected to the first extending portion 114A and the second extending portion 114B. The supporting portion 116 is located in the bottom portion 112. In some embodiments, the bottom portion 112 wraps the supporting portion 116. The spacer 118 is disposed between the first extending portion 114A and the second extending portion 114B. The two terminals 130 are separated by the spacer 118. More specifically, the cavity CV is further defined by the spacer 118, the first extending portion 114A, and the second extending portion 114B.

Reference is made again to FIG. 4. In this embodiment, the extending arm 136 abuts against the supporting portion 116. More specifically, the abutting portion 1366 of the extending arm 136 abuts against the supporting portion 116. As shown in FIG. 4, the first bending portion 1362 of the terminal 130 on the second extending portion 114B bends toward the spacer 118 (i.e., away from the second extending portion 114B). The second bending portion 1364 of the terminal 130 on the second extending portion 114B bends away from the spacer 118 (i.e., toward the second extending portion 114B), so that the abutting portion 1366 is located directly below the second extending portion 114B and directly on the supporting portion 116.

As shown in FIG. 4, in some embodiments, the first extending portion 114A and the second extending portion 114B respectively include a first hook 1142A and a second hook 1142B on the top thereof. In some embodiments, the first extending portion 114A and the second extending portion 114B respectively have a thickness extending in a direction (e.g., x-direction). The thickness of the first extending portion 114A and the thickness of the second extending portion 114B taper upward, as shown in FIG. 4.

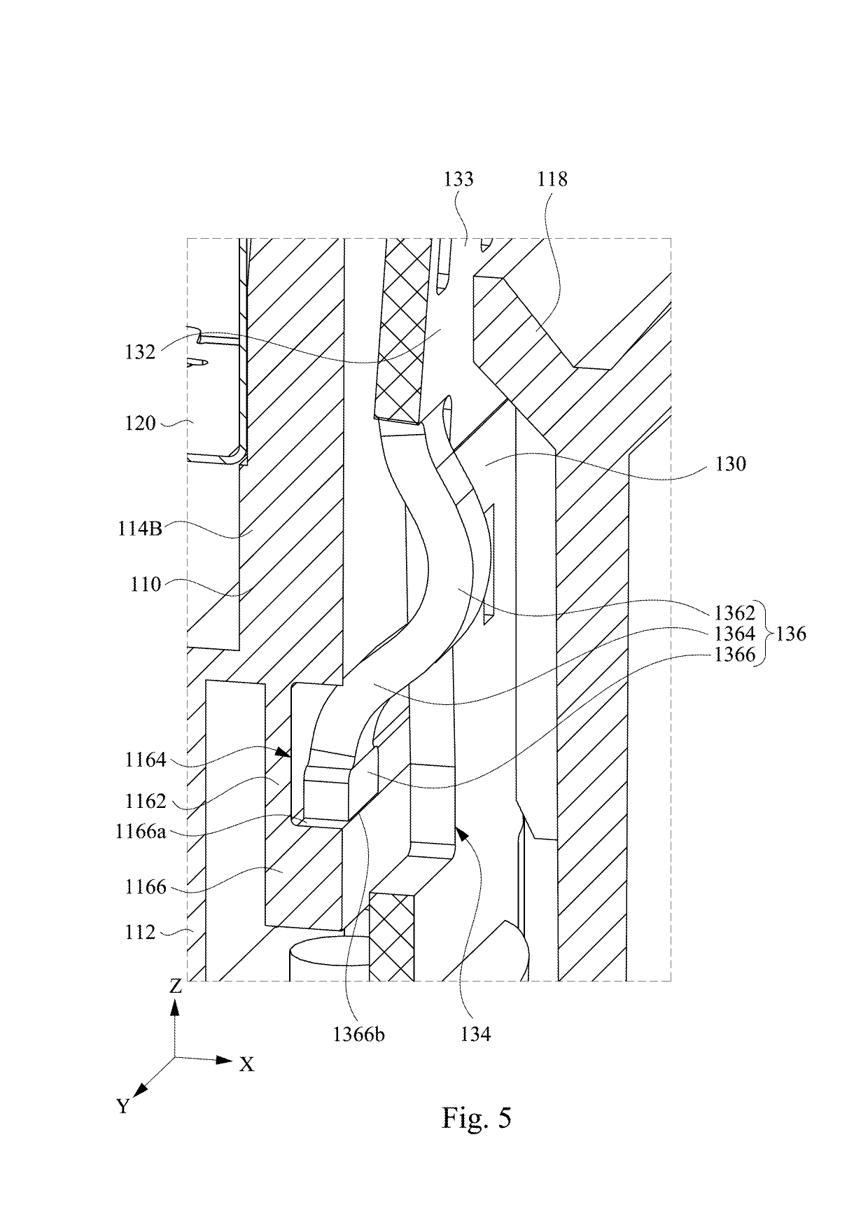

FIG. 5 is an enlarged view of the connector 100 in FIG. 4 in accordance with an embodiment of the present disclosure. As shown in FIG. 5, in this embodiment, the supporting portion 116 includes a hanging wall 1162, a groove 1164, and a platform 1166. The hanging wall 1162 is connected to the first extending portion 114A and the second extending portion 114B. More specifically, there are two hanging walls 1162 respectively connected to the first extending portion 114A and the second extending portion 114B. The platform 1166 is connected to the hanging wall 1162. As shown in FIG. 5, the platform 1166 is floating in the bottom portion 112. More specifically, the platform 1166 is separated to the bottom portion 112 via a gap. The groove 1164 is defined by the hanging wall 1162, the platform 1166, and one of the first extending portion 114A and the second extending portion 114B. The abutting portion 1366 has a bottom surface 1366b. The platform 1166 has a top surface 1166a. As shown in FIG. 5, the bottom surface 1366b of the abutting portion 1366 abuts against the top surface 1166a of the platform 1166. The abutting portion 1366 is accommodated in the groove 1164. In other words, the abutting portion 1366 is located directly below the second extending portion 114B and directly above the platform 1166 of the supporting portion 116.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A connector, comprising:
a housing, comprising:
a bottom portion;
an extending portion protruding from the bottom portion; and
a supporting portion located in the bottom portion; and
a terminal connected to the housing, the terminal comprising a main body and an extending arm extending from the main body, the extending arm abutting against the supporting portion, and the extending arm being wavy-shaped.

2. The connector of claim 1, wherein the extending arm further comprises:
a first bending portion extending from the main body;
a second bending portion connected to the first bending portion; and
an abutting portion connected to the second bending portion and abutting against the supporting portion.

3. The connector of claim 2, wherein the supporting portion further comprises:
a hanging wall extending from the extending portion; and
a platform connected to the hanging wall, the platform being separated to the bottom portion via a gap,
wherein a groove is defined by the hanging wall, the platform, and the extending portion.

4. The connector of claim 3, wherein a bottom surface of the abutting portion abuts against a top surface of the platform.

5. The connector of claim 2, wherein the main body has an inner surface and an outer surface on both sides of the main body, and wherein the first bending portion is raised with respect to the outer surface of the main body and the second bending portion is raised with respect to the inner surface of the main body.

6. The connector of claim 2, wherein a width of the abutting portion tapers upward.

7. The connector of claim 1, wherein the terminal further comprises:
a curling portion protruding from the main body; and
a bump on the main body,
wherein an opening is located on the main body and accommodates the extending arm.

8. A connector, comprising:
a housing, comprising:
a bottom portion;
an extending portion protruding from the bottom portion;
a wing portion laterally connected to the extending portion; and
a supporting portion connected to the extending portion and being located in the bottom portion; and
a terminal connected to the housing, wherein the terminal comprises a main body and an extending arm extending from the main body, the extending arm abutting against the supporting portion, wherein the extending arm further comprises:
a first bending portion extending from the main body of the terminal, at least a part of the first bending portion being located at an inner side of the main body;
a second bending portion connected to the first bending portion, at least a part of the second bending portion being located at an outer side of the main body; and
an abutting portion connected to the second bending portion and abutting against the supporting portion.

9. The connector of claim 8, wherein the supporting portion further comprises:
a hanging wall connected to the extending portion; and
a platform connected to the hanging wall and being separated to the bottom portion via a gap, wherein a groove is defined by the hanging wall, the platform, and the extending portion, and wherein a bottom surface of the abutting portion abuts against a top surface of the platform.

10. The connector of claim 8, wherein the main body has an inner surface and an outer surface on both sides of the main body, and wherein the first bending portion is raised with respect to the outer surface of the main body, and the second bending portion is raised with respect to the inner surface of the main body.

11. The connector of claim 8, wherein a width of the abutting portion tapers upward.

12. The connector of claim 8, wherein a width of the abutting portion is greater than a width of the second bending portion.

13. The connector of claim 8, wherein the abutting portion has an inverted capital-T shape.

14. The connector of claim 8, further comprising two grounded sheets connected to the extending portion, and wherein the two grounded sheets are separated from the terminal.

15. A connector, comprising:
a housing, comprising:
a bottom portion;
a first extending portion and a second extending portion protruding from the bottom portion, wherein the bottom portion, the first extending portion, and the second extending portion jointly define a cavity; and
a supporting portion connected to the first extending portion and the second extending portion and being located in the bottom portion; and
two terminals partly located in the cavity, wherein one of the two terminals comprises a main body and an extending arm extending from the main body, wherein the extending arm abuts against the supporting portion, the extending arm being wavy-shaped, wherein the extending arm further comprises:
a first bending portion extending from the main body of the one of the two terminals;
a second bending portion connected to the first bending portion; and
an abutting portion connected to the second bending portion and abutting against the supporting portion.

16. The connector of claim 15, wherein the supporting portion further comprises:
a hanging wall connected to the first extending portion or the second extending portion; and
a platform connected to the hanging wall and being separated to the bottom portion via a gap, wherein a groove is defined by the hanging wall, the platform, and one of the first extending portion and the second extending portion, and wherein a bottom surface of the abutting portion abuts against a top surface of the platform.

17. The connector of claim 16, wherein the abutting portion is accommodated in the groove.

18. The connector of claim 15, wherein the main body has an inner surface and an outer surface on both sides of the main body, and wherein the first bending portion is raised with respect to the outer surface of the main body, and the second bending portion is raised with respect to the inner surface of the main body.

19. The connector of claim 15, wherein the housing further comprises a spacer disposed between the first extending portion and the second extending portion, and the two terminals are separated by the spacer.

20. The connector of claim 19, wherein the cavity is defined by the spacer, the first extending portion, and the second extending portion.
